(19) United States
(12) Patent Application Publication
(10) Pub. No.: US 2026/0321138 A1
(43) Pub. Date: Oct. 15, 2026

(54) BACKEND DEVICE

(71) Applicant: Robert Bosch GmbH, Stuttgart (DE)

(72) Inventor: Stefan Nordbruch, Leonberg (DE)

(21) Appl. No.: 19/104,481

(22) PCT Filed: Oct. 11, 2023
(86) PCT No.: PCT/EP2023/078160

§ 371 Date: Feb. 18, 2025

(30) Foreign Application Priority Data
Oct. 18, 2022 (DE) 10 2022 210 994.5

(51) Int. Cl. G08G 1/0967; H04W 4/44

(52) U.S. Cl. CPC G08G 1/096783; G08G 1/096725; H04W 4/44

(57) ABSTRACT

A backend device. The backend device includes: a communication unit, which is configured to receive infrastructure assistance data for a motor vehicle driving in an at least partially automated manner within an infrastructure, from at least one infrastructure system for the infrastructure-supported assistance of the motor vehicle during its at least partially automated travel through the infrastructure; wherein the communication unit is configured to forward the received infrastructure assistance data to the motor vehicle in accordance with a safety specification, wherein the safety specification states that infrastructure assistance data of an infrastructure system for infrastructure-supported assistance of a motor vehicle during its at least partially automated travel through an infrastructure must be forwarded unchanged and directly to the motor vehicle. A method for operating a backend device, a computer program, and a machine-readable storage medium, are also described.

### FIELD

The present invention relates to a backend device, to a method for operating a backend device, to a computer program, and to a machine-readable storage medium.

### BACKGROUND INFORMATION

U.S. Patent Application Publication No. US 2021/0389137 A1 describes a method for coordinating multimodal transport services.

U.S. Patent Application Publication No. US 2022/0185315 A1 describes a method for authenticating autonomous vehicle traffic networks.

German Patent Application No. DE 10 2018 216 492 A1 describes a backend device.

### SUMMARY

An object of the present invention is to provide efficient forwarding infrastructure assistance data to a motor vehicle.

This object may be achieved by means of certain features of the present invention. Advantageous example embodiments of the present invention are disclosed herein.

According to a first aspect of the present invention, a backend device is provided. According to an example embodiment of the present invention, the backend device includes:
a communication unit, which is configured to receive infrastructure assistance data for a motor vehicle driving in an at least partially automated manner within an infrastructure, from at least one infrastructure system for the infrastructure-supported assistance of the motor vehicle during its at least partially automated travel through the infrastructure,
wherein the communication unit is configured to forward the received infrastructure assistance data to the motor vehicle in accordance with a safety specification, wherein the safety specification states that infrastructure assistance data of an infrastructure system for infrastructure-supported assistance of a motor vehicle during its at least partially automated travel through an infrastructure must be forwarded unchanged and directly to the motor vehicle.

According to a second aspect of the present invention, a method for operating a backend device according to the first aspect is provided. According to an example embodiment of the present invention, the method comprises the following steps:
receiving, by means of the communication unit, infrastructure assistance data for a motor vehicle driving in an at least partially automated manner within an infrastructure, from at least one infrastructure system for infrastructure-supported assistance of the motor vehicle during its at least partially automated travel through the infrastructure,
forwarding, by means of the communication unit, the received infrastructure assistance data to the motor vehicle in accordance with a safety specification, wherein the safety specification states that infrastructure assistance data of an infrastructure system for infrastructure-supported assistance of a motor vehicle during its at least partially automated travel through an infrastructure must be forwarded unchanged and directly to the motor vehicle.

According to a third aspect of the present invention, a computer program is provided which comprises commands that, when the computer program is executed by a computer, for example by the backend device according to the first aspect, cause the computer to carry out a method according to the second aspect of the present invention.

According to a fourth aspect of the present invention, a machine-readable storage medium is provided on which the computer program according to the third aspect of the present invention is stored.

According to an example embodiment of the present invention, the above object may be achieved by the backend device forwarding the infrastructure assistance data unchanged and directly to the motor vehicle. This means that there are no unnecessary delays on the backend device side when the infrastructure assistance data are forwarded to the motor vehicle. The fact that the infrastructure assistance data are forwarded unchanged, i.e., are not changed, results in the technical advantage that specified safety requirements can be met efficiently.

This therefore in particular results in the technical advantage that the infrastructure assistance data can be efficiently forwarded to the motor vehicle by means of the backend device.

The concept described here therefore ensures in particular that the infrastructure system for infrastructure-supported assistance of the motor vehicle does not transmit the infrastructure assistance data directly to the motor vehicle during its at least partially automated travel through the infrastructure. Rather, it is in particular provided for the infrastructure system to transmit the infrastructure assistance data to the backend device, which then forwards the received infrastructure assistance data unchanged and directly to the motor vehicle.

Up to now, such infrastructure systems have transmitted their infrastructure assistance data directly to the motor vehicle. With an increasing number of such infrastructure systems, a corresponding number of infrastructure systems would therefore communicate directly with the motor vehicle, i.e., in particular transmit infrastructure assistance data to it. This can generate a great deal of technical effort on the part of a motor vehicle manufacturer or an OEM (original equipment manufacturer), which may, for example, be due to the fact that communication interfaces on the motor vehicle side must be implemented and maintained for communication with the infrastructure systems. A motor vehicle manufacturer or an OEM can therefore, for example, decide to limit external access to the motor vehicle to a backend device. This means, for example, that communication with the motor vehicle is only possible via such a backend device.

An infrastructure system for infrastructure-supported assistance of a motor vehicle during at least partially automated travel through an infrastructure depends on certain safety requirements being met. For example, delay times for transmitting infrastructure assistance data to the motor vehicle must not be too long. For example, it must be ensured that the infrastructure assistance data are not changed on the way to the motor vehicle.

Safety requirements are defined or specified, for example, according to ASIL and/or according to SIL.

The abbreviation “ASIL” stands for “automotive safety integrity level.” “Automotive safety integrity level” is a key component of the standard ISO 26262. ASIL distinguishes between four different ASIL risk levels, which are designated ASIL-A, ASIL-B, ASIL-C and ASIL-D.

The abbreviation “SIL” stands for “safety integrity level.” “Safety integrity level” is a key component of the standard IEC EN 61508. SIL distinguishes between four different SIL risk levels, which are designated SIL-1, SIL-2, SIL-3 and SIL-4.

By ensuring on the backend device side that the infrastructure assistance data transmitted from the infrastructure system are forwarded unchanged and directly by the backend device to the motor vehicle, it can be ensured in an efficient and advantageous manner that such safety requirements according to ASIL and/or according to SIL are met.

For example, at least partially automated driving functions of the motor vehicle depend on certain infrastructure assistance data being as up-to-date as possible. In particular, such a partially automated driving function of the motor vehicle depends on the infrastructure assistance data not being changed after they have been generated and transmitted by the infrastructure system, since, for example, the at least partially automated driving function expects these infrastructure assistance data in a certain format in order to be able to process them accordingly. The features of the present invention disclosed herein thus advantageously allows an at least partially automated driving function of the motor vehicle to work efficiently and safely with such infrastructure assistance data.

An infrastructure system is, for example, an AVP system. An infrastructure system is, for example, an IAD system.

The abbreviation “AVP” stands for “automated valet parking.” The abbreviation “IAD” stands for “infrastructure assisted driving.”

According to an example embodiment of the present invention, an infrastructure system is therefore a system that assists a motor vehicle during its at least partially automated travel through an infrastructure. The motor vehicle therefore receives assistance from the infrastructure during its at least partially automated travel through the infrastructure.

For this purpose, the infrastructure system generates infrastructure assistance data, on the basis of which the motor vehicle can, for example, drive in an at least partially automated manner.

Infrastructure-supported assistance of the motor vehicle means in particular that infrastructure assistance data are made available to the motor vehicle. The motor vehicle can, for example, derive instructions for action on the basis of the infrastructure assistance data. For example, the motor vehicle can decide for itself what to do on the basis of the infrastructure assistance data.

Infrastructure assistance data include, for example, one or more of the following data elements: control command for at least partially automated control of lateral and/or longitudinal guidance of the motor vehicle; remote control command for at least partially automated remote control of lateral and/or longitudinal guidance of the motor vehicle; enable command for enabling at least partially automated, in particular fully automated, travel of the motor vehicle for a certain time in a certain region of the parking lot, in general infrastructure; target trajectory for the motor vehicle; target position within the parking lot, in general infrastructure; environmental data representing an environment of the motor vehicle; specification of what the motor vehicle should do. The specification specifies, for example, whether the motor vehicle is allowed to drive or whether it must stop.

At least partially automated travel of the motor vehicle within an infrastructure is therefore travel of the motor vehicle in which the motor vehicle is guided in an at least partially automated manner. The motor vehicle therefore drives such that it is guided in an at least partially automated manner within the infrastructure.

The wording “at least partially automated guidance” comprises one or more of the following cases: assisted guidance, partially automated guidance, highly automated guidance, fully automated guidance. The wording “at least partially automated” thus comprises one or more of the following formulations: assisted, partially automated, highly automated, fully automated. At least partially automated guidance of the motor vehicle therefore comprises at least partially automated control of lateral and/or longitudinal guidance of the motor vehicle.

Assisted guidance means that a driver of the motor vehicle continuously carries out either the lateral or longitudinal guidance of the motor vehicle. The relevant other driving task (i.e., control of the longitudinal or lateral guidance of the motor vehicle) is carried out automatically. This means that, with assisted guidance of the motor vehicle, either the lateral or the longitudinal guidance is controlled automatically.

Partially automated guidance means that in a specific situation (for example: driving on a freeway, driving within a parking lot, overtaking an object, driving within a lane defined by lane markings) and/or for a certain period of time, longitudinal and lateral guidance of the motor vehicle are automatically controlled. A driver of the vehicle does not have to manually control the longitudinal and lateral guidance of the motor vehicle. However, the driver must continuously monitor the automatic control of the longitudinal and lateral guidance in order to be able to intervene manually if necessary. The driver must be prepared to fully take over the motor vehicle at any time.

Highly automated guidance means that for a certain period of time in a specific situation (for example: driving on a freeway, driving within a parking lot, overtaking an object, driving within a lane defined by lane markings), longitudinal and a lateral guidance of the motor vehicle are automatically controlled. A driver of the vehicle does not have to manually control the longitudinal and lateral guidance of the motor vehicle. The driver does not have to continuously monitor the automatic control of the longitudinal and lateral guidance in order to be able to intervene manually if necessary. If required, a prompt to take over the control of the longitudinal and lateral guidance is automatically output to the driver, in particular output with a sufficient time reserve. The driver therefore potentially has to be able to take over the control of the longitudinal and lateral guidance. Limitations of the automatic control of the lateral and longitudinal guidance are automatically detected. In highly automated guidance, it is not possible to bring about a state of minimal risk automatically in every starting situation.

Fully automated guidance means that in a specific situation (for example: driving on a freeway, driving within a parking lot, overtaking an object, driving within a lane defined by lane markings), longitudinal and lateral guidance of the motor vehicle are automatically controlled. A driver of the vehicle does not have to manually control the longitudinal and lateral guidance of the motor vehicle. The driver does not have to monitor the automatic control of the longitudinal and lateral guidance in order to be able to intervene manually if necessary. Before the automatic control of the lateral and longitudinal guidance is terminated, the driver is automatically prompted to take over the driving task (controlling the lateral and longitudinal guidance of the motor vehicle), in particular with a sufficient time reserve. If the driver does not take over the driving task, a return to a state of minimal risk is automatically made. Limitations of the automatic control of the lateral and longitudinal guidance are automatically detected. In all situations, it is possible to return to a system state of minimal risk automatically.

The terms “assist” and “support” can be used synonymously.

The wording “at least one” means “one or more.”

For example, it is provided for one or more environmental sensors to be spatially distributed within the infrastructure and to sense their respective surroundings or environment and to output environmental data that correspond to the sensory detection or are based on the sensory detection and describe the respective environments of the environmental sensors. For example, the infrastructure system generates the infrastructure assistance data on the basis of such environmental data.

An environmental sensor is, for example, one of the following environmental sensors: radar sensor; ultrasonic sensor; LIDAR sensor; magnetic field sensor; infrared sensor; image sensor, in particular image sensor of a video camera; chemical sensor; temperature sensor; acoustic sensor, for example microphone; gas sensor, for example carbon monoxide sensor or carbon dioxide sensor.

In one example embodiment of the backend device of the present invention, it is provided for the safety specification to be implemented in the communication unit.

This, for example, results in the technical advantage that the communication unit is efficiently informed of the safety specification.

In one example embodiment of the backend device of the present invention, it is provided for it to comprise a control unit, which is configured to control the communication unit on the basis of the safety specification in such a way that it forwards infrastructure assistance data of an infrastructure system for infrastructure-supported assistance of a motor vehicle during its at least partially automated travel through an infrastructure unchanged and directly to the motor vehicle.

This, for example, results in the technical advantage that the safety specification can be met efficiently.

For example, the safety specification is implemented in the control unit.

For example, the infrastructure assistance data are included in a message.

For example, the safety specification is implemented in corresponding firmware, in particular firmware of the backend device and/or the communication unit and/or the control unit and/or the checking unit described below and/or a communication interface of the communication unit.

In one example embodiment of the backend device of the present invention, it is provided for the safety specification to be integrated in a message comprising the infrastructure assistance data, wherein the communication unit is configured to receive the message from the infrastructure system and to read the safety specification from the message.

This, for example, results in the technical advantage that the communication unit can be efficiently informed of the safety specification that must be met.

According to this example embodiment, it is therefore provided for the infrastructure system to generate a message and transmit it to the backend device, wherein this message comprises the infrastructure assistance data, and wherein the safety specification is integrated in this message.

In one example embodiment of the backend device of the present invention, it is provided for the safety specification to be integrated at a predetermined position in the message, wherein the communication unit is configured to read the safety specification at the predetermined position.

This, for example, results in the technical advantage that the communication unit can efficiently read the safety specification from the message.

In one example embodiment of the backend device of the present invention, it is provided for the communication unit to have multiple communication interfaces, wherein at least one of the multiple communication interfaces is provided for receiving infrastructure assistance data of an infrastructure system for infrastructure-supported assistance of a motor vehicle during its at least partially automated travel through an infrastructure so that the communication unit is configured, upon receipt of infrastructure assistance data, in particular a message comprising the infrastructure assistance data, from an infrastructure system for infrastructure-supported assistance of a motor vehicle during its at least partially automated travel through an infrastructure by means of the at least one of the multiple communication interfaces, to forward the received infrastructure assistance data unchanged and directly to the motor vehicle.

This, for example, results in the technical advantage that the safety specification can be met efficiently.

According to this example embodiment of the present invention, it is therefore provided in particular for it to be defined that data received by means of the at least one of the multiple communication interfaces are forwarded unchanged and directly to the motor vehicle. The safety specification is therefore implemented in particular in the at least one of the multiple communication interfaces.

In one example embodiment of the backend device of the present invention, it is provided for the communication unit to be configured to receive an announcement message from an infrastructure system for infrastructure-supported assistance of a motor vehicle during its at least partially automated travel through an infrastructure, which message announces infrastructure assistance data of the infrastructure system for a motor vehicle, wherein the communication unit is configured, upon receipt of the infrastructure assistance data of the infrastructure system for the motor vehicle, to forward the received infrastructure assistance data unchanged and directly to the motor vehicle on the basis of the announcement message.

This, for example, results in the technical advantage that the safety specification can be met efficiently.

According to this example embodiment of the present invention, it is therefore in particular provided for the infrastructure system to announce that it is transmitting infrastructure assistance data.

The announcement message indicates, for example, a future period within which the infrastructure system transmits infrastructure assistance data, so that infrastructure assistance data received by the communication unit within the period are forwarded unchanged and directly to the motor vehicle.

For example, each time before transmitting infrastructure assistance data, an infrastructure system transmits an announcement message. This means, for example, that infrastructure assistance data are announced each time by an infrastructure system.

The announcement message is received, for example, on the same communication interface that receives the infrastructure assistance data or on another communication interface of the communication unit.

Generally, the communication unit comprises one or more communication interfaces, for example the first and second communication interfaces described below.

In one example embodiment of the backend device of the present invention, it is provided for the communication unit to have a first communication interface and a second communication interface, wherein the first communication interface is configured to receive the infrastructure assistance data from the infrastructure system, and wherein the second communication interface is configured to forward the received infrastructure assistance data to the motor vehicle in accordance with the safety specification.

This, for example, results in the technical advantage that the infrastructure assistance data can be received efficiently and forwarded efficiently. According to this example embodiment of the present invention, it is therefore provided for there to be two communication interfaces on the backend device side. A first communication interface is provided for communication between the backend device and the infrastructure system. A second communication interface is provided for communication between the backend device and the motor vehicle.

The communication unit is, for example, configured to communicate via a wireless communication network. For example, the infrastructure assistance data can be received from the infrastructure system via a wireless communication network. The infrastructure assistance data can thus be forwarded to the motor vehicle via a wireless communication network, for example.

A wireless communication network comprises, for example, a mobile radio network and/or a WLAN network.

The first communication interface and/or the second communication interface is, for example, a WLAN interface or a mobile radio network interface or comprises one or more such interfaces.

In one example embodiment of the backend device of the present invention, it is provided for the safety specification to be implemented in the communication unit and/or implemented in the backend device and/or implemented in the control unit and/or implemented in one or more of the communication interfaces and/or implemented or integrated in the message and/or implemented in one of the firmwares described above and/or implemented in the checking unit. Thus, there are several possibilities of, for example, how the communication unit is informed that it must forward infrastructure assistance data from an infrastructure system unchanged and directly to the motor vehicle, and/or, for example, how the backend device can work or be operated according to the safety specification.

A communication interface of the communication unit is, for example, a WLAN interface or a mobile radio network interface or comprises one or more such interfaces.

In one example embodiment of the backend device of the present invention, it is provided for it to comprise a checking unit, which is configured to check whether the safety specification is met.

This, for example, results in the technical advantage that it is possible to efficiently check whether the safety specification is met or not.

For example, it is provided for the communication unit to be configured to terminate or interrupt the forwarding of infrastructure assistance data if the check result indicates that the safety specification is not met. This can, for example, result in the technical advantage that it can be efficiently ensured that potentially unsafe data are not forwarded to the motor vehicle.

If no more infrastructure assistance data are forwarded to the motor vehicle, the motor vehicle will therefore no longer receive any infrastructure assistance data. For example, on the motor vehicle side, this is a sign that an error must have occurred on the backend device side and/or on the infrastructure system side so that an emergency plan can be executed in the motor vehicle. For example, in such a case, the motor vehicle can be brought into a safe state, such as a standstill. For example, the motor vehicle can prompt a driver of the motor vehicle to assume control of the motor vehicle in such a case.

Embodiments of the backend device of the present invention apply analogously to the method of the present invention, and vice versa. This means in particular that method features result from features of the backend device, and vice versa. Technical functionalities of the method result analogously from corresponding technical functionalities of the backend device, and vice versa.

In one example embodiment of the method of the present invention, it is provided for the safety specification to be implemented in the communication unit.

In one example embodiment of the method of the present invention, it is provided for the safety specification to be integrated in a message comprising the infrastructure assistance data, wherein the message is received from the infrastructure system by the communication unit, wherein the safety specification is read from the message by the communication unit.

In one example embodiment of the method of the present invention, it is provided for the safety specification to be integrated at a predetermined position in the message, wherein the safety specification is read at the predetermined position by the communication unit.

In one example embodiment of the method of the present invention, it is provided for the communication unit to have a first communication interface and a second communication interface, wherein the infrastructure assistance data are received from the infrastructure system by means of the first communication interface, wherein the received infrastructure assistance data are forwarded to the motor vehicle by means of the second communication interface in accordance with the safety specification.

In one example embodiment of the method of the present invention, it is provided for the backend device to comprise a checking unit, wherein the checking unit checks whether the safety specification is met.

In one example embodiment of the backend device of the present invention, it is provided for it to be configured in terms of programming to execute the computer program according to the third aspect.

In one example embodiment of the backend device of the present invention, it is provided for it to be configured to carry out the method according to the second aspect.

The method according to the second aspect of the present invention is, for example, a computer-implemented method. For example, the method according to the second aspect is implemented on the backend device or is in an implemented state on the backend device.

The infrastructure comprises, for example, one or more of the following infrastructure elements: parking lot, freeway, junction, intersection, on-ramp, off-ramp, roundabout, road, intersection, T-junction, freeway on-ramp, freeway off-ramp, tunnel, tunnel entrance, tunnel exit, construction site, lane narrowing, bridge, bridge passage.

The present invention is explained in more detail below using preferred exemplary embodiments.

### BRIEF DESCRIPTION OF THE DRAWINGS

FIG. 1 shows a first backend device, according to an example embodiment of the present invention.

FIG. 2 shows a second backend device, according to an example embodiment of the present invention.

FIG. 3 shows a flow chart of a method for operating a backend device, according to an example embodiment of the present invention.

FIG. 4 shows a machine-readable storage medium, according to an example embodiment of the present invention.

FIG. 5 shows communication between a motor vehicle, a third backend device and an infrastructure system, according to an example embodiment of the present invention.

FIG. 6 shows, by way of example, the third backend device according to FIG. 5 forwarding a message comprising infrastructure assistance data, according to an example embodiment of the present invention.

### DETAILED DESCRIPTION OF EXAMPLE EMBODIMENTS

In the following, the same reference signs can be used for identical features.

FIG. 1 shows a first backend device 101, comprising: a communication unit 103, which is configured to receive infrastructure assistance data for a motor vehicle driving in an at least partially automated manner within an infrastructure, from at least one infrastructure system for infrastructure-supported assistance of the motor vehicle during its at least partially automated travel through the infrastructure, wherein the communication unit 103 is configured to forward the received infrastructure assistance data to the motor vehicle in accordance with a safety specification, wherein the safety specification states that infrastructure assistance data of an infrastructure system for infrastructure-supported assistance of a motor vehicle during its at least partially automated travel through an infrastructure must be forwarded unchanged and directly to the motor vehicle.

The communication unit 103 is therefore in particular configured to receive the infrastructure assistance data from the infrastructure system and to forward them unchanged and directly to the motor vehicle.

The forwarding comprises, for example, transmitting the infrastructure assistance data to the motor vehicle, in particular transmitting them via a wireless communication network.

Unchanged means, for example, that a checksum of the received infrastructure assistance data is equal to a checksum of the forwarded infrastructure assistance data.

Infrastructure assistance data are therefore routed in particular through the communication unit.

Directly means in particular that the infrastructure assistance data are forwarded to the motor vehicle in response to the receipt of the infrastructure assistance data. Directly therefore means that no unnecessary delays are permitted, except in particular those which are technically indispensable.

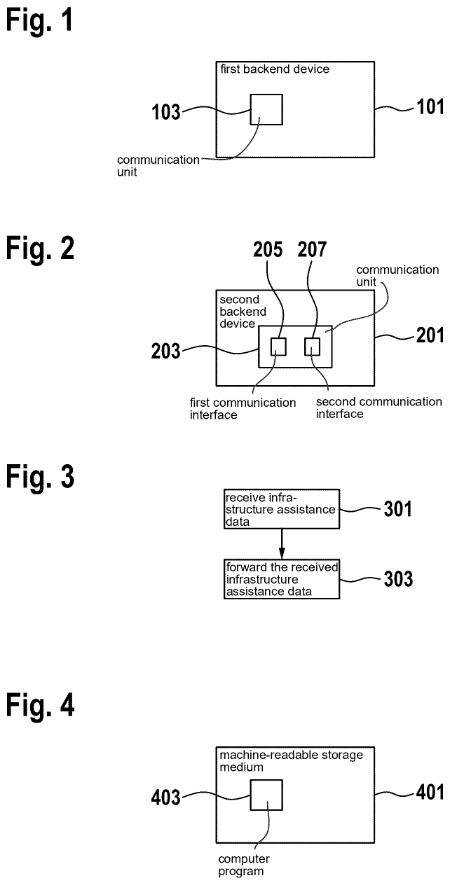

FIG. 2 shows a second backend device 201, comprising: a communication unit 203, which is configured to receive infrastructure assistance data for a motor vehicle driving in an at least partially automated manner within an infrastructure, from at least one infrastructure system for infrastructure-supported assistance of the motor vehicle during its at least partially automated travel through the infrastructure,
wherein the communication unit 203 is configured to forward the received infrastructure assistance data to the motor vehicle in accordance with a safety specification, wherein the safety specification states that infrastructure assistance data of an infrastructure system for infrastructure-supported assistance of a motor vehicle during its at least partially automated travel through an infrastructure must be forwarded unchanged and directly to the motor vehicle.

The communication unit 203 comprises a first communication interface and a second communication interface, wherein the first communication interface 205 is configured to receive the infrastructure assistance data from the infrastructure system, and wherein the second communication interface 207 is configured to forward the received infrastructure assistance data to the motor vehicle in accordance with the safety specification.

FIG. 3 shows a flow chart of a method for operating a backend device according to the first aspect, comprising the following steps:
receiving 301, by means of the communication unit, infrastructure assistance data for a motor vehicle driving in an at least partially automated manner within an infrastructure, from at least one infrastructure system for infrastructure-supported assistance of the motor vehicle during its at least partially automated travel through the infrastructure,
forwarding 303, by means of the communication unit, the received infrastructure assistance data to the motor vehicle in accordance with a safety specification, wherein the safety specification states that infrastructure assistance data of an infrastructure system for infrastructure-supported assistance of a motor vehicle during its at least partially automated travel through an infrastructure must be forwarded unchanged and directly to the motor vehicle.

FIG. 4 shows a machine-readable storage medium 401, on which a computer program 403 is stored. The computer program 403 comprises commands that, when the computer program 403 is executed by a computer, cause the computer to carry out a method according to the first aspect.

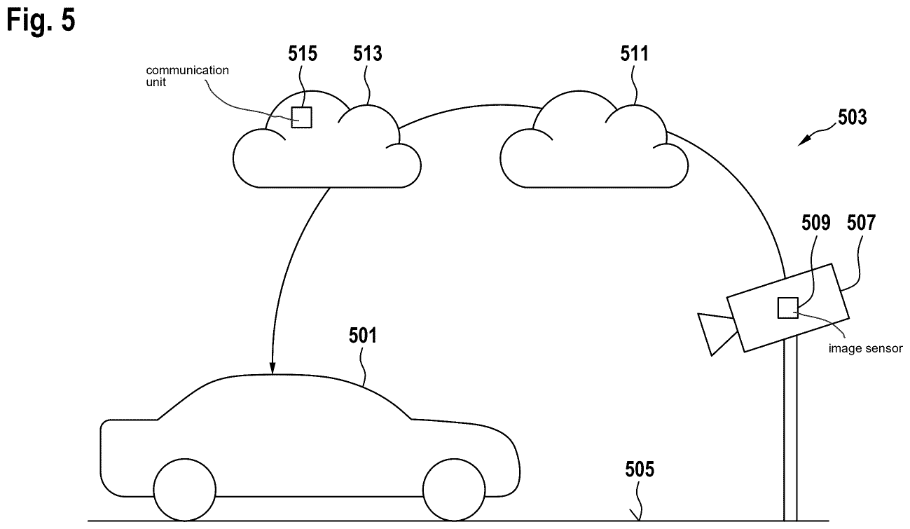

FIG. 5 shows a motor vehicle 501 during at least partially automated travel within an infrastructure 503. The infrastructure 503 comprises a road 505, on which the motor vehicle 501 travels. The road 505 is, for example, a freeway or, for example, a country road. The infrastructure 503 can, for example, comprise a parking lot so that the motor vehicle 501 drives, for example, within a parking lot.

A video camera 507 comprising an image sensor 509 is arranged within the infrastructure 503. The video camera 507 records video images of an environment of the motor vehicle 501 and transmits these video images to an infrastructure system 511 for infrastructure-supported assistance of a motor vehicle during at least partially automated travel through the infrastructure 503. The infrastructure system 511 is, for example, an AVP system when the motor vehicle 501 is driving within a parking lot, for example, or is, for example, an IAD system when the motor vehicle 501 is driving on a road, in particular a freeway, for example.

The infrastructure system 511 ascertains infrastructure assistance data on the basis of the video images of the video camera 507 and transmits them to a third backend device 513 comprising a communication unit 515, which is configured accordingly, as already explained in the description.

The communication unit 515 receives the infrastructure assistance data transmitted by the infrastructure system 511 and forwards them unchanged and directly to the motor vehicle 501.

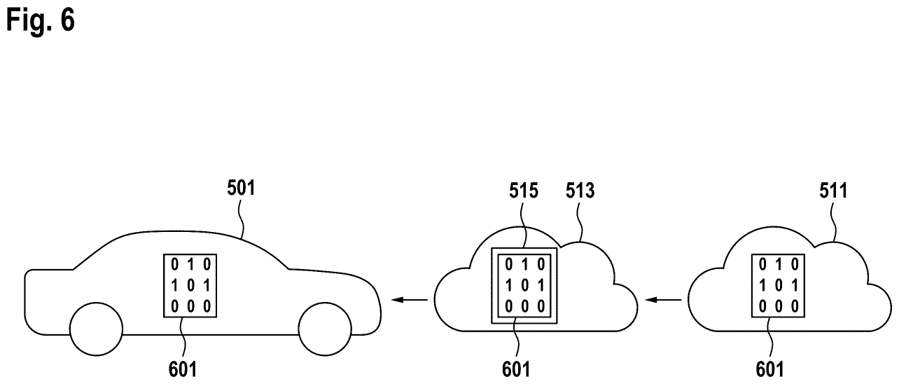

FIG. 6 shows the motor vehicle 501, the infrastructure system 511 and the third backend device 513 during corresponding forwarding of a message 601 comprising infrastructure assistance data, which are symbolically represented in FIG. 6 by zeros and ones.

The message 601 comprising infrastructure assistance data is generated by the infrastructure system 511 and transmitted by the infrastructure system 511 to the backend device 513. The communication unit 515 receives the message 601 and forwards it directly and unchanged to the motor vehicle 501. The fact that the communication unit 515 forwards the message 601 unchanged to the motor vehicle 501 is shown in FIG. 6 in that the zeros and ones were not changed during forwarding.

1-12. (canceled)

13. A backend device, comprising:
a communication unit configured to receive infrastructure assistance data for a motor vehicle driving in an at least partially automated manner within an infrastructure, from at least one infrastructure system for infrastructure-supported assistance of the motor vehicle during an at least partially automated travel through the infrastructure;
wherein the communication unit is configured to forward the received infrastructure assistance data to the motor vehicle in accordance with a safety specification, wherein the safety specification states that the infrastructure assistance data of the infrastructure system for infrastructure-supported assistance of the motor vehicle during its at least partially automated travel through an infrastructure must be forwarded unchanged and directly to the motor vehicle.

14. The backend device according to claim 13, wherein the safety specification is implemented in the communication unit.

15. The backend device according to claim 13, further comprising:
a control unit configured to control the communication unit based on the safety specification in such a way that the communication unit forwards the infrastructure assistance data of the infrastructure system for infrastructure-supported assistance of the motor vehicle during the at least partially automated travel through an infrastructure unchanged and directly to the motor vehicle.

16. The backend device according to claim 13, wherein the safety specification is integrated in a message including the infrastructure assistance data, wherein the communication unit is configured to receive the message from the infrastructure system and to read the safety specification from the message.

17. The backend device according to claim 16, wherein the safety specification is integrated at a predetermined position in the message, wherein the communication unit is configured to read the safety specification at the predetermined position.

18. The backend device according to claim 13, wherein the communication unit includes multiple communication interfaces, wherein at least one of the multiple communication interfaces is configured to receive infrastructure assistance data of an infrastructure system for infrastructure-supported assistance of a motor vehicle during its at least partially automated travel through an infrastructure so that the communication is configured, upon receipt of infrastructure assistance data of an infrastructure system for infrastructure-supported assistance of a motor vehicle during its at least partially automated travel through an infrastructure using the at least one of the multiple communication interfaces, to forward the received infrastructure assistance data unchanged and directly to the motor vehicle.

19. The backend device according to claim 13, wherein the communication unit is configured to receive an announcement message from the infrastructure system for infrastructure-supported assistance of the motor vehicle during the at least partially automated travel through the infrastructure, the message announcing infrastructure assistance data of the infrastructure system for the motor vehicle, wherein the communication unit is configured, upon receipt of the infrastructure assistance data of the infrastructure system for the motor vehicle, to forward the received infrastructure assistance data unchanged and directly to the motor vehicle based on the announcement message.

20. The backend device according to claim 13, wherein the communication unit has a first communication interface and a second communication interface, wherein the first communication interface is configured to receive the infrastructure assistance data from the infrastructure system, and wherein the second communication interface is configured to forward the received infrastructure assistance data to the motor vehicle in accordance with the safety specification.

21. The backend device according to claim 13, further comprising a checking unit, which is configured to check whether the safety specification is met.

22. A method for operating a backend device, comprising the following steps:
receiving, using a communication unit of the backend, infrastructure assistance data for a motor vehicle driving in an at least partially automated manner within an infrastructure, from at least one infrastructure system for infrastructure-supported assistance of the motor vehicle during its at least partially automated travel through the infrastructure; and
forwarding, using the communication unit, the received infrastructure assistance data to the motor vehicle in accordance with a safety specification, wherein the safety specification states that the infrastructure assistance data of the infrastructure system for the infrastructure-supported assistance of the motor vehicle during the at least partially automated travel through the infrastructure must be forwarded unchanged and directly to the motor vehicle.

23. A non-transitory machine-readable storage medium on which is stored a computer program for operating a backend device, the computer program, when executed by a computer, causing the computer to perform the following steps:
receiving, using a communication unit of the backend, infrastructure assistance data for a motor vehicle driving in an at least partially automated manner within an infrastructure, from at least one infrastructure system for infrastructure-supported assistance of the motor vehicle during its at least partially automated travel through the infrastructure; and
forwarding, using the communication unit, the received infrastructure assistance data to the motor vehicle in accordance with a safety specification, wherein the safety specification states that the infrastructure assistance data of the infrastructure system for the infrastructure-supported assistance of the motor vehicle during the at least partially automated travel through the infrastructure must be forwarded unchanged and directly to the motor vehicle.
